(19) United States
(12) Patent Application Publication
(10) Pub. No.: US 2020/0254743 A1
(43) Pub. Date: Aug. 13, 2020

(54) MULTILAYER FILM AND TWO-LIQUID CURABLE COATING AGENT

(71) Applicant: HARIMA CHEMICALS, INC., Kakogawa-shi, Hyogo (JP)

(72) Inventors: Masao KIGUCHI, Kakogawa-shi, Hyogo (JP); Nobuyuki MATSUOKA, Kakogawa-shi, Hyogo (JP); Ryoichi NAKAI, Kakogawa-shi, Hyogo (JP)

(73) Assignee: HARIMA CHEMICALS, INC., Kakogawa-shi, Hyogo (JP)

(21) Appl. No.: 16/642,420

(22) PCT Filed: Aug. 28, 2018
(86) PCT No.: PCT/JP2018/031789

§ 371 Date: Feb. 27, 2020

(30) Foreign Application Priority Data
Aug. 31, 2017 (JP) 2017-166521
Mar. 30, 2018 (JP) PCT/JP2018/013911

(51) Int. Cl. B32B 27/40; B32B 7/12; C08G 18/67; C08G 18/38; C09D 175/06

(52) U.S. Cl. CPC B32B 27/40; B32B 7/12; C08F 20/22; C08G 18/3855; C09D 175/06; C08G 18/672

(57) ABSTRACT

A multilayer film includes a substrate layer; a surface protective layer integrally laminated on a first surface of the substrate layer, the surface protective layer containing a polyurethane which is a reaction product of a polyol (P) having a hydroxyl value of 25 to 380 mgKOH/g and a content of fluorine atoms of 0.01 to 20% by mass and a polyisocyanate (I); and an adhesive layer integrally laminated on a second surface of the substrate layer. Also described is a two-liquid curable coating agent for forming the surface protective layer.

### CROSS-REFERENCE TO RELATED APPLICATION

The present application claims the priority under Japanese Patent Application No. 2017-166521 filed on Aug. 31, 2017 and the priority under International application No. PCT/JP2018/013911 filed on Mar. 30, 2018, the disclosures of which are hereby incorporated in their entirety by reference.

### TECHNICAL FIELD

The present invention relates to a multilayer film including a surface protective layer excellent in water spot resistance and scratch resistance and a two-liquid curable coating agent for forming the surface protective layer.

### BACKGROUND ART

A surface treatment is conventionally performed to an article such as an automobile, a vehicle, an airplane, glass, a building, and a signboard for protecting the article from a dirt and a scratch and maintaining appearance of the article. Such a surface treatment is performed by applying a surface protective layer to the article surface. Examples of a method of the surface treatment include (1) a method in which a two-liquid curable coating agent is applied to the article surface to form a surface protective layer and (2) a method in which a multilayer film including a surface protective layer and an adhesive layer is adhered to the article surface.

For example, Patent Literature 1 discloses, in Example 1, an adhesive sheet that includes a surface protective layer containing a polyurethane prepared by reacting 100 parts of a (meth)acryl-based polymer having a hydroxyl value of 45 mgKOH and 28.07 parts of an isocyanate-based crosslinking agent, a substrate layer, and an adhesive layer.

### CITATION LIST

### Patent Literature

Patent Literature 1: Japanese Patent Application Laid-Open No. 2015-52100

### SUMMARY OF INVENTION

### Technical Problem

Water sometimes adheres to an article having been subjected to the surface treatment as a liquid droplet due to rainfall, washing, or the like, which may cause stain commonly called “water spot.” The water spot is a phenomenon in which mineral components and the like contained in the water are deposited and remain as a white mark after the adhered water evaporates. The occurrence of the water spot deteriorates appearance of the article surface. Thus, it is required that the surface protective layer have improved water spot resistance.

Further, appearance of the article surface having been subjected to the surface treatment may deteriorate due to a scratch caused by contact or collision of a flying object such as a pebble and a sand dust. Thus, it is also required that the surface protective layer exhibit excellent scratch resistance.

Therefore, an object of the present invention is to provide a multilayer film including a surface protective layer excellent in water spot resistance and scratch resistance and a two-liquid curable coating agent for forming the surface protective layer.

### Solution to Problem

[Multilayer Film]

The multilayer film of the present invention is characterized by including:

a substrate layer;

a surface protective layer integrally laminated on a first surface of the substrate layer, the surface protective layer containing a polyurethane which is a reaction product of a polyol (P) having a hydroxyl value of 25 to 380 mgKOH/g and a content of fluorine atoms of 0.01 to 20% by mass and a polyisocyanate (I); and

an adhesive layer integrally laminated on a second surface of the substrate layer.

[Surface Protective Layer]

The multilayer film of the present invention includes the surface protective layer integrally laminated on the first surface of the substrate layer. The surface protective layer includes the polyurethane which is the reaction product of the polyol (P) having a hydroxyl value of 25 to 380 mgKOH/g and a content of fluorine atoms of 0.01 to 20% by mass and the polyisocyanate (I). Note that any surface of the substrate layer serves as the “first surface of the substrate layer” and a surface of the substrate layer on the opposite side to the first surface serves as the “second surface of the substrate layer.” It is preferable that either or both of the first surface and the second surface of the substrate layer have the maximum area of the substrate layer.

[Polyol (P)]

In the present invention, the polyol (P) having a hydroxyl value of 25 to 380 mgKOH/g is used, and the polyurethane prepared by reacting this polyol (P) and the polyisocyanate (I) is contained in the surface protective layer. A urethane bond included in the polyurethane can impart appropriate hydrophilicity to the surface of the surface protective layer. This causes water adhered to the surface protective layer to spread on the surface of the surface protective layer and thus can prevent the formation of a liquid droplet, which makes it possible to improve the water spot resistance of the surface protective layer. Thus, it becomes possible to reduce the occurrence of stain called “water spot” caused by the water adhered to the surface protective layer. That is, the spread of the water adhered to the surface protective layer over time to lower a contact angle of the water can reduce a concentration of the mineral components included in the water per unit area of the surface of the surface protective layer and lessen the deposition of the mineral components as a white mark (i.e., “water spot”) on the surface protective layer after evaporation of the water. For example, such an effect can be evaluated on the basis of a “change rate of contact angle” in the evaluation of the water spot resistance in Example to be described below. The change rate of the contact angle evaluates how much the contact angle of a water droplet decreases 300 seconds after the water droplet is adhered to the surface protective layer.

Further, in the present invention, the use of the polyol (P) having a content of fluorine atoms of 0.01 to 20% by mass allows the surface protective layer to exhibit appropriate water repellency immediately after water has been in contact with the surface of the surface protective layer (hereinafter, also simply referred to as “initial water repelling property”). This makes it possible to repel the water that has been in contact with the surface of the surface protective layer and thereby reduce adhesion of the water to the surface protective layer. Further, for example, the initial water repelling property can be evaluated on the basis of an “initial contact angle” in the evaluation of the water spot resistance in Example to be described below. The higher “initial contact angle” means that the surface protective layer exhibits the higher water repellency immediately after the water has been in contact with the surface of the surface protective layer.

It is considered that, as described above, both the water repellency and the hydrophilicity of the surface protective layer contribute to the water spot resistance of the surface protective layer. In the present invention, the use of the polyol (P) described above makes it possible to impart the appropriate water repellency and hydrophilicity to the surface protective layer and thereby improve the water spot resistance of the surface protective layer.

Further, the water spot resistance of the surface protective layer can be evaluated comprehensively on the basis of both the “change rate of contact angle” and the “initial contact angle” in the evaluation of the water spot resistance in Example. In particular, the “change rate of contact angle” more significantly contributes to the water spot resistance. Thus, a surface protective layer (A₁) having a large change rate of contact angle and a low initial contact angle tends to be comprehensively more excellent in the water spot resistance than a surface protective layer (A₂) having a small change rate of contact angle and a high initial contact angle.

On the other hand, the multilayer film is adhered to an article surface by placing the multilayer film on the article surface and then pressing and sliding a squeegee (spatula) on the surface protective layer. According to the studies by the present inventors, it is revealed that simply improving the hydrophilicity of the surface protective layer for the purpose of improving the water spot resistance of the surface protective layer sometimes causes a reduction in squeegee slidability on the surface protective layer. In such a case, the squeegee does not slide smoothly and is caught on the surface protective layer, resulting in the occurrence of a scratch on the surface protective layer. It is found that, as described above, there is a case where the water spot resistance and the squeegee slidability are contradictory to each other on the surface protective layer, and the improvement of one property deteriorates the other property.

Thus, in the present invention, the polyol (P) having a content of fluorine atoms set to 0.01 to 20% by mass makes it possible to impart the excellent squeegee slidability to the surface protective layer while minimizing the reduction in the water spot resistance. In this manner, it becomes possible to provide the surface protective layer excellent in both the water spot resistance and the squeegee slidability.

Further, in the present invention, the use of the polyurethane prepared by reacting the polyol (P) having a hydroxyl value of 25 to 380 mgKOH/g and a content of fluorine atoms of 0.01 to 20% by mass and the polyisocyanate (I) can also improve the scratch resistance of the surface protective layer. This makes it possible to maintain the appearance by reducing the occurrence of a scratch caused by contact or collision of a flying object such as a pebble and a sand dust on the surface protective layer.

On the other hand, as described above, for adhering the multilayer film to the article surface, the squeegee is pressed and slid on the surface protective layer after the multilayer film is placed on the article surface. In this process, a tensile force is applied to the multilayer film by the squeegee. Thus, some multilayer films that cannot resist the tensile force by the squeegee may sometimes be teared. In the present invention, the surface protective layer uses the polyurethane prepared by reacting the polyol (P) having a hydroxyl value of 25 to 380 mgKOH/g and a content of fluorine atoms of 0.01 to 20% by mass and the polyisocyanate (I), and thus the multilayer film that is flexible and excellent in stretchability can also be provided. This enables the multilayer film to be resistant to the tensile force by the squeegee at the time of adhering the multilayer film to the article surface and makes it possible to reduce the occurrence of tear in the multilayer film.

The hydroxyl value of the polyol (P) is 25 mgKOH/g or more, preferably 45 mgKOH/g or more, more preferably 70 mgKOH/g or more, further preferably 110 mgKOH/g or more, and most preferably 120 mgKOH/g or more. On the other hand, the hydroxyl value of the polyol (P) is 380 mgKOH/g or less, preferably 340 mgKOH/g or less, more preferably 300 mgKOH/g or less, further preferably 220 mgKOH/g or less, particularly preferably 180 mgKOH/g or less, and most preferably 150 mgKOH/g or less. The use of the polyol (P) having the hydroxyl value within the above-described range can form a polyurethane having an appropriate amount of urethane bonds, which makes it possible to improve the water spot resistance of the surface protective layer. The polyol (P) having the hydroxyl value set to 380 mgKOH/g or less can improve the water repellency (initial water repelling property) of the surface protective layer to reduce adhesion of a large amount of water onto the surface protective layer as a liquid droplet, thereby reducing the occurrence of the water spot. Further, the polyol (P) having the hydroxyl value set to 380 mgKOH/g or less can improve the squeegee slidability of the surface protective layer and the stretchability of the multilayer film. On the other hand, the polyol (P) having the hydroxyl value set to 25 mgKOH/g or more can achieve spreading of water adhered to the surface protective layer over time, which makes it possible to lower a concentration of the mineral components per unit area of the surface of the surface protective layer and lessen the deposition of the mineral components as a white mark (i.e., “water spot”) after evaporation of the water. Further, the polyol (P) having the hydroxyl value set to 25 mgKOH/g or more can also improve the scratch resistance of the surface protective layer. Note that, in the present invention, the hydroxyl value of the polyol (P) refers to a hydroxyl value in a solid content.

Note that the hydroxyl value of the polyol (P) refers to a value measured in accordance with the 4.2 B method of “Plastics—Polyols for use in the production of polyurethane—Part 1: Determination of hydroxyl value” in JIS K 1557-1:2007 (ISO 14900:2001).

The content of fluorine atoms of the polyol (P) is 0.010% by mass or more, preferably 0.030% by mass or more, more preferably 0.080% by mass or more, more preferably 0.20% by mass or more, further preferably 0.40% by mass or more, and most preferably 0.80% by mass or more. On the other hand, the content of the fluorine atoms of the polyol (P) is 20% by mass or less, but preferably 19% by mass or less, more preferably 18% by mass or less, more preferably 12% by mass or less, further preferably 5.0% by mass or less, still further preferably 2.00% by mass or less, and most preferably 1.50% by mass or less. Fluorine atoms contained in the polyol (P) can improve the water repellency (initial water repelling property) and squeegee slidability of the surface protective layer, but the fluorine atoms may lower the hydrophilicity of the surface protective layer to reduce the water spot resistance. However, the polyol (P) having the content of fluorine atoms set within the above-described range can impart excellent squeegee slidability to the surface protective layer while suppressing the reduction of the water spot resistance. The polyol (P) having the content of fluorine atoms set to 0.010% by mass or more can improve the initial water repelling property of the surface protective layer to reduce adhesion of a large amount of water onto the surface protective layer as a liquid droplet, thereby reducing the occurrence of the water spot. Further, the polyol (P) having the content of fluorine atoms set to 0.010% by mass or more can also improve the squeegee slidability and the scratch resistance of the surface protective layer. In addition, the polyol (P) having the content of fluorine atoms set to 20% by mass or less can spread the water adhering to the surface protective layer over time, thereby improving the water spot resistance.

It is preferable that the polyol (P) do not include an aromatic ring in the molecule thereof. The polyol (P) that does not include an aromatic ring in the molecule thereof can impart excellent weather resistance to the surface protective layer. This can reduce yellowing of the surface protective layer over time.

((Meth)acrylic polyol)

It is preferable that the polyol (P) contain a (meth)acrylic polyol. The (meth)acrylic polyol is obtained by reacting a (meth)acryl-based monomer, and is a (meth)acryl-based polymer having a hydroxyl group at its terminal or side chain. The (meth)acrylic polyol can be obtained by polymerizing a (meth)acryl-based monomer using a common method for producing an acrylic polymer in the presence of a radical polymerization initiator. The use of the (meth)acrylic polyol can improve both the water spot resistance and squeegee slidability of the surface protective layer.

Note that (meth)acrylic means acrylic or methacrylic, and (meth)acrylate described below means acrylate or methacrylate.

As the (meth)acrylic polyol, a polymer of (meth)acryl-based monomers containing a fluorine-containing (meth)acryl-based monomer (a1) and a hydroxyl group-containing (meth)acryl-based monomer (a2) is preferable. The use of such a polymer can improve both the water spot resistance and the squeegee slidability of the surface protective layer. The (meth)acrylic polyol may be used alone or two or more kinds thereof may be used in combination.

The fluorine-containing (meth)acryl-based monomer (a1) preferably has a fluorine atom in its side chain, and more preferably does not have a fluorine atom directly bonded to a carbon atom constituting the main chain.

As the fluorine-containing (meth)acryl-based monomer (a1), the (meth)acryl-based monomer represented by the following formula (1) is preferable.

CH₂=C(R¹)—COO—(CH₂)ₙ—Rf¹ (1)

(in the formula (1), R¹ is a hydrogen atom or a methyl group, n is an integer of 0 to 10, and Rf¹ is a fluoroalkyl group in which the alkyl group has 1 to 20 carbons and at least one hydrogen atom of the alkyl group is substituted with a fluorine atom.)

The fluoroalkyl group represented by Rf¹ in the formula (1) may be linear or branched. The number of carbon atoms of the fluoroalkyl group is preferably 1 to 20, and more preferably 3 to 18. Examples of the alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-dodecyl group, an n-tetradecyl group, an n-hexadecyl group, an n-octadecyl group, an n-icosyl group, an isopropyl group, an isobutyl group, a sec-butyl group, a tert-butyl group, a neopentyl group, a tert-pentyl group, and an n-(2-ethyl)hexyl group.

In the fluoroalkyl group, at least one of the hydrogen atoms of the alkyl group is substituted with a fluorine atom, but it is preferable that all of the hydrogen atoms bonded to the primary carbon atom be substituted with a fluorine atom, and it is more preferable that all of the hydrogen atoms of the alkyl group be substituted with a fluorine atom.

Specific examples of the fluorine-containing (meth)acryl-based monomer (a1) include trifluoroethyl(meth)acrylate, 2 (perfluorobutyl)ethyl(meth)acrylate, 2-(perfluorohexyl)ethyl(meth)acrylate, 2-(perfluorooctyl)ethyl(meth)acrylate, 2,2,3,3-tetrafluoropropyl(meth)acrylate, hexafluoro-2-propyl(meth)acrylate, and heptafluoro-2-propylacrylate. Among these, 2-(perfluorohexyl)ethyl(meth)acrylate is preferable, and 2-(perfluorohexyl)ethyl acrylate is more preferable. The fluorine-containing (meth)acryl-based monomer (a1) may be used alone or two or more kinds thereof may be used in combination.

The content of the fluorine-containing (meth)acryl-based monomer (a1) unit in the (meth)acrylic polyol is preferably 0.50% by mass or more, more preferably 0.70% by mass or more, and further preferably 0.90% by mass or more. On the other hand, the content of the fluorine-containing (meth)acryl-based monomer (a1) unit in the (meth)acrylic polyol is preferably 50% by mass or less, more preferably 40% by mass or less, further preferably 20% by mass or less, and particularly preferably 3.0% by mass or less. The fluorine-containing (meth)acryl-based monomer (a1) unit contained in an amount of 0.50% by mass or more can improve the initial water repelling property of the surface protective layer, thereby improving the water spot resistance. The fluorine-containing (meth)acryl-based monomer (a1) unit contained in an amount of 0.50% by mass or more can also improve the squeegee slidability and scratch resistance of the surface protective layer. In addition, the fluorine-containing (meth)acryl-based monomer (a1) unit contained in an amount of 50% by mass or less can spread water adhering to the surface protective layer over time, thereby improving the water spot resistance of the surface protective layer.

As the hydroxyl group-containing (meth)acryl-based monomer (a2), a (meth)acrylic acid alkyl ester containing a hydroxyl group is mentioned. Examples of the hydroxyl group-containing (meth)acryl-based monomer (a2) include 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, and 12-hydroxylauryl(meth)acrylate. Among these, 2-hydroxyethyl(meth)acrylate is preferable. The hydroxyl group-containing (meth)acryl-based monomer (a2) may be used alone or two or more kinds thereof may be used in combination.

The content of the hydroxyl group-containing (meth)acryl-based monomer (a2) unit in the (meth)acrylic polyol is preferably 4% by mass or more, more preferably 10% by mass or more, and further preferably 22% by mass or more. On the other hand, the content of the hydroxyl group-containing (meth)acryl-based monomer (a2) unit in the (meth)acrylic polyol is preferably 90% by mass or less, more preferably 82% by mass or less, and further preferably 60% by mass or less. The hydroxyl group-containing (meth)acryl-based monomer (a2) unit contained in an amount of 4% by mass or more can spread the water adhering to the surface protective layer over time, thereby improving the water spot resistance. The hydroxyl group-containing (meth)acryl-based monomer (a2) unit contained in an amount of 4% by mass or more can also improve the scratch resistance of the surface protective layer. On the other hand, the hydroxyl group-containing (meth)acryl-based monomer (a2) unit contained in an amount of 90% by mass or less can improve the initial water repelling property of the surface protective layer, thereby improving the water spot resistance. Further, the hydroxyl group-containing (meth)acryl-based monomer (a2) unit contained in an amount of 90% by mass or less can also improve the squeegee slidability of the surface protective layer.

In the (meth)acrylic polyol, the mass ratio of the fluorine-containing (meth)acryl-based monomer (a1) unit to the hydroxyl group-containing (meth)acryl-based monomer (a2) unit, [the mass of the fluorine-containing (meth)acryl-based monomer (a1) unit/the mass of the hydroxyl group-containing (meth)acryl-based monomer (a2) unit], is preferably 0.0030 or more, more preferably 0.0070 or more, more preferably 0.020 or more, more preferably 0.025 or more, further preferably 0.030 or more, particularly preferably 0.033 or more, and most preferably 0.050 or more. The mass ratio [(a1)/(a2)] set to 0.0030 or more can improve the squeegee slidability and the water spot resistance of the surface protective layer. In the (meth)acrylic polyol, the mass ratio of the fluorine-containing (meth)acryl-based monomer (a1) unit to the hydroxyl group-containing (meth)acryl-based monomer (a2) unit, [the mass of the fluorine-containing (meth)acryl-based monomer (a1) unit/the mass of the hydroxyl group-containing (meth)acryl-based monomer (a2) unit], is preferably 7.5 or less, more preferably 5.0 or less, more preferably 2.0 or less, more preferably 1.0 or less, more preferably 0.90 or less, further preferably 0.70 or less, particularly preferably 0.30 or less, and most preferably 0.12 or less. The mass ratio [(a1)/(a2)] set to 7.5 or less can improve the water spot resistance of the surface protective layer.

It is preferable that the (meth)acryl-based monomer used for polymerization of the (meth)acrylic polyol contain a siloxane bond-containing (meth)acryl-based monomer (a3). Specifically, as the (meth)acrylic polyol, a polymer of (meth)acryl-based monomers containing the fluorine-containing (meth)acryl-based monomer (a1), the hydroxyl group-containing (meth)acryl-based monomer (a2), and the siloxane bond-containing (meth)acryl-based monomer (a3) is preferable. The use of the siloxane bond-containing (meth)acryl-based monomer (a3) can impart excellent scratch resistance and squeegee slidability to the surface protective layer.

As the siloxane bond-containing (meth)acryl-based monomer (a3), monomers represented by the following formula (2) or (3) are preferable.

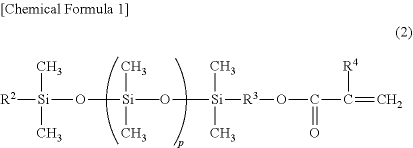

(In the formula (2), R² represents an alkyl group having 1 to 12 carbon atoms, R³ represents an alkylene group having 1 to 10 carbon atoms, R⁴ represents a hydrogen atom or a methyl group, and p represents an integer of 2 to 150.)

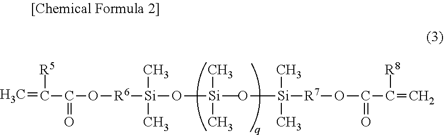

(In the formula (3), R⁵ and R⁸ are each a hydrogen atom or a methyl group, R⁶ and R⁷ are each an alkylene group having 1 to 10 carbon atoms, and q represents an integer of 2 to 150.)

The number of carbons of the alkyl group represented by R² in the formula (2) is preferably 1 to 12, and more preferably 1 to 5. Examples of the alkyl group represented by R² include a methyl group, an ethyl group, an n-propyl group, an n-butyl group, an n-pentyl group, an n-hexyl group, and an n-hexyl group. The number of carbons of the alkylene group represented by R³ in the formula (2) is preferably 1 to 10, and more preferably 1 to 5. Examples of the alkylene group represented by R³ include a methylene group, an ethylene group, an n-propylene group, and an n-butylene group.

The number of carbons of the alkylene group represented by R⁶ and R⁷ in the formula (3) is preferably 1 to 10, and more preferably 1 to 5. Examples of the alkylene group represented by R⁶ and R⁷ include a methylene group, an ethylene group, an n-propylene group, and an n-butylene group. The R⁶ and the R⁷ may be the same as or different from each other.

Specific examples of the siloxane bond-containing (meth)acryl-based monomer (a3) include α-butyl-ω-(3-methacryloxypropyl)polydimethylsiloxane, α-mono(methacryloxymethyl)polydimethylsiloxane, and α,ω-di(methacryloxymethyl)polydimethylsiloxane. Among these, α-butyl-ω-(3-methacryloxypropyl)polydimethylsiloxane is preferable. The siloxane bond-containing (meth)acryl-based monomer (a3) may be used alone or two or more kinds thereof may be used in combination.

The content of the siloxane bond-containing (meth)acryl-based monomer (a3) unit in the (meth)acrylic polyol is preferably 0.1% by mass or more, more preferably 1% by mass or more, further preferably 5% by mass or more, and particularly preferably 9% by mass or more. The content of the siloxane bond-containing (meth)acryl-based monomer (a3) unit in the (meth)acrylic polyol is preferably 30% by mass or less, more preferably 25% by mass or less, and further preferably 20% by mass or less. The siloxane bond-containing (meth)acryl-based monomer (a3) unit contained in an amount within the above-described range can provide a surface protective layer excellent in scratch resistance and squeegee slidability.

The (meth)acryl-based monomer used in the polymerization of the (meth)acrylic polyol may contain other (meth)acryl-based monomers than the aforementioned fluorine-containing (meth)acryl-based monomer (a1), hydroxyl-containing (meth)acryl-based monomer (a2), and siloxane bond-containing (meth)acryl-based monomer (a3). As the other (meth)acryl-based monomers, a (meth)acryl-based monomer (a4) which does not contain a fluorine, hydroxyl group and siloxane bond is mentioned.

As the (meth)acrylic polyol, a polymer of (meth)acryl-based monomers containing the fluorine-containing (meth)acryl-based monomer (a1), the hydroxyl group-containing (meth)acryl-based monomer (a2), and the (meth)acryl-based monomer (a4) that does not contain a fluorine, hydroxyl group and siloxane bond, or a polymer of (meth)acryl-based monomers containing the fluorine group-containing (meth)acryl-based monomer (a1), the hydroxyl group-containing (meth)acryl-based monomer (a2), the siloxane bond-containing (meth)acryl-based monomer (a3), and the (meth)acryl-based monomer (a4) that does not contain a fluorine, hydroxyl group and siloxane bond is preferable.

Examples of the (meth)acryl-based monomer (a4) that does not contain a fluorine, hydroxyl group and siloxane bond include a (meth)acrylic acid alkyl ester that does not contain a fluorine, hydroxyl group and siloxane bond. Specific examples thereof include methyl(meth)acrylate, ethyl(meth)acrylate, propyl(meth)acrylate, butyl(meth)acrylate, pentyl(meth)acrylate, hexyl(meth)acrylate, heptyl(meth)acrylate, octyl(meth)acrylate, 2-ethylhexyl(meth)acrylate, nonyl(meth)acrylate, decyl(meth)acrylate, benzyl(meth)acrylate, dicyclopentadienyl(meth)acrylate, cyclohexyl(meth)acrylate, 4-butylcyclohexyl(meth)acrylate, dicyclopentanyl(meth)acrylate, dicyclopentenyl(meth)acrylate, dicyclopentadienyl(meth)acrylate, isobornyl (meth) acrylate, and tricyclodecanyl(meth)acrylate. Among these, methyl(meth)acrylate, butyl(meth)acrylate, and isobornyl(meth)acrylate are preferable, and methylmethacrylate, butylacrylate, and isobornylmethacrylate are more preferable. The (meth)acryl-based monomer (a4) that does not contain a fluorine, hydroxyl group and siloxane bond may be used alone or two or more kinds thereof may be used in combination.

In the (meth)acrylic polyol, the content of the (meth)acryl-based monomer (a4) unit that does not contain a fluorine, hydroxyl group and siloxane bond is preferably 10% by mass or more, and more preferably 15% by mass or more. On the other hand, in the (meth)acrylic polyol, the content of the (meth)acryl-based monomer (a4) unit that does not contain a fluorine, hydroxyl group and siloxane bond is preferably 95% by mass or less, and more preferably 90% by mass or less.

The content of the (meth)acrylic polyol in the polyol (P) is preferably 0.1% by mass or more, more preferably 10% by mass or more, and further preferably 20% by mass or more. On the other hand, the content of the (meth)acrylic polyol in the polyol (P) is preferably 90% by mass or less, more preferably 80% by mass or less, and further preferably 65% by mass or less.

(Other Polyols)

The polyol (P) may contain other polyols than the (meth)acrylic polyol described above. As the other polyols, a polyether polyol, a polyester polyol, and a polycarbonate polyol are mentioned. The use of these polyols can improve the scratch resistance of the surface protective layer and the stretchability of the multilayer film. The other polyols may be used alone or two or more kinds thereof may be used in combination.

As the polyether polyol, an aliphatic polyether polyol and an alicyclic polyether polyol are mentioned. Examples of the aliphatic polyether polyol include polyvalent alcohols such as polyethylene glycol, polypropylene glycol, polytetramethylene glycol, polyhexamethylene glycol, polyheptamethylene glycol, polydecamethylene glycol, pentaerythritol, dipentaerythritol, trimethylolpropane, and alkylene oxide addition polyols such as an ethylene oxide addition triol of trimethylolpropane, a propylene oxide addition triol of trimethylolpropane, an ethylene oxide and propylene oxide addition triol of trimethylolpropane, an ethylene oxide addition tetraol of pentaerythritol, and ethylene oxide addition hexaol of dipentaerythritol, and polyether polyols obtained by ring-opening polymerization of two or more kinds of ion-polymerizable cyclic compound.

Examples of the ion polymerizable cyclic compound include ethylene oxide, propylene oxide, butene-1-oxide, isobutene oxide, 3,3-bis(chloromethyl)oxetane, tetrahydrofuran, 2-methyltetrahydrofuran, dioxane, trioxane, tetraoxane, cyclohexene oxide, styrene oxide, epichlorohydrin, glycidyl ether, allylglycidyl ether, allylglycidyl carbonate, butadiene monooxide, isoprene monooxide, vinyl oxetane, vinyl tetrahydrofuran, vinyl cyclohexene oxide, phenylglycidyl ether, butylglycidyl ether, and benzoic acid glycidyl ether. Examples of the specific combinations of two or more ion polymerizable cyclic compounds described above include tetrahydrofuran and ethylene oxide, tetrahydrofuran and propylene oxide, tetrahydrofuran and 2-methyltetrahydrofuran, tetrahydrofuran and 3-methyltetrahydrofuran, ethylene oxide and propylene oxide, butene-1-oxide and ethylene oxide, and tetrahydrofuran, butene-1-oxide and ethylene oxide.

Examples of the alicyclic polyether polyols include an alkylene oxide addition diol of hydrogenated bisphenol A, an alkylene oxide addition diol of hydrogenated bisphenol F, and an alkylene oxide addition diol of 1,4-cyclohexanediol.

As the polyether polyol, an aliphatic polyether polyol is preferable, and polytetramethylene glycol is more preferable.

The content of the polyether polyol in the polyol (P) is preferably 0.1% by mass or more, more preferably 10% by mass or more, and further preferably 30% by mass or more. On the other hand, the content of the polyether polyol in the polyol (P) is preferably 90% by mass or less, more preferably 80% by mass or less, and further preferably 70% by mass or less.

Examples of the polyester polyol include polycondensates obtained by reacting a low molecular weight polyol and a polybasic acid under known conditions.

As the low molecular weight polyol, a compound having two or more hydroxyl groups and a molecular weight of less than 400, preferably less than 300, is mentioned. Examples of the low molecular weight polyol include dihydric alcohols, such as ethylene glycol, propylene glycol, 1,3-propanediol, 1,4-butylene glycol, 1,3-butylene glycol, 1,2-butylene glycol, 1,5-pentanediol, 1,6-hexanediol, neopentyl glycol, 3-methyl-1,5-pentanediol, 2,2,2-trimethylpentanediol, 3,3-dimethylol heptane, alkane (C7 to 20) diol, 1,3- or 1,4-cyclohexanedimethanol and a mixture thereof, 1,3- or 1,4-cyclohexanediol and a mixture thereof, hydrogenated bisphenol A, 1,4-dihydroxy-2-butene, 2,6-dimethyl-1-octene-3,8-doil, bisphenol A, diethylene glycol, triethylene glycol, and dipropylene glycol; trihydric alcohols such as glycerin, trimethylolpropane, and triisopropanolamine; tetrahydric alcohols such as tetramethylolmethane (pentaerythritol) and diglycerin; pentahydric alcohols such as xylitol; hexahydric alcohols such as sorbitol, mannitol, allitol, iditol, dulcitol, altritol, inositol, and dipentaerythritol; heptahydric alcohols such as perseitol; and octahydric alcohols such as sucrose.

Examples of the polybasic acids include oxalic acid, malonic acid, succinic acid, methylsuccinic acid, glutaric acid, adipic acid, 1,1-dimethyl-1,3-dicarboxypropane, 3-methyl-3-ethylglutaric acid, azelaic acid, sebacic acid, and other saturated aliphatic dicarboxylic acids (C11 to 13); maleic acid, fumaric acid, itaconic acid, and other unsaturated dicarboxylic acids; orthophthalic acid, isophthalic acid, terephthalic acid, toluenedicarboxylic acid, naphthalenedicarboxylic acid, and other aromatic dicarboxylic acids; hexahydrophthalic acid, and other alicyclic dicarboxylic acids; other carboxylic acids such as dimer acid, hydrogenated dimer acid and het acid, and acid anhydrides derived from these carboxylic acids; oxalic anhydride, succinic anhydride, maleic anhydride, phthalic anhydride, 2-alkyl (C12 to C18) succinic anhydride, tetrahydrophthalic anhydride, trimellitic anhydride, and acid halides derived from these carboxylic acids; and oxalic acid dichloride, adipic acid dichloride, and sebacic acid dichloride.

Examples of the polyester polyol include a polycaprolactone polyol, a polyvalerolactone polyol, and a lactone-based polyester polyol obtained by copolymerizing at least one of these compounds with the dihydric alcohol described above. The polycaprolactone polyol is obtained by ring-opening polymerization of lactones such as ε-caprolactone using the low molecular weight polyol (preferably, dihydric alcohol), described above, serving as an initiator. The polyvalerolactone polyol is obtained by ring-opening polymerization of lactones such as γ-valerolactone using the low molecular weight polyol (preferably, dihydric alcohol), described above, serving as an initiator.

As the polyester polyol, a lactone-based polyester polyol and a polycaprolactone polyol are preferable, and a polycaprolactone triol is more preferable.

The content of the polyester polyol in the polyol (P) is preferably 0.1% by mass or more, more preferably 10% by mass or more, and further preferably 30% by mass or more. On the other hand, the content of the polyester polyol in the polyol (P) is preferably 90% by mass or less, more preferably 80% by mass or less, and further preferably 70% by mass or less.

Examples of the polycarbonate polyol include a ring-opening polymer of ethylene carbonate using the low molecular weight polyol (preferably, dihydric alcohol), described above, serving as an initiator, and an amorphous polycarbonate polyol obtained by copolymerizing a ring-opening polymer with a dihydric alcohol such as 1,4-butanediol, 1,5-pentanediol, 3-methyl-1,5-pentanediol and 1,6-hexanediol.

Specific examples of the polycarbonate polyol include a polyhexamethylene carbonate diol, a polypentamethylene carbonate diol, a polytetramethylene carbonate diol, a poly(tetramethylene/hexamethylene) carbonate diol, and a poly[cyclohexylene bis(methylene)/hexamethylene] carbonate diol. The poly(tetramethylene/hexamethylene) carbonate diol is a copolymer of 1,4-butanediol and 1,6-hexanediol with dialkyl carbonate. The poly[cyclohexylene bis(methylene)/hexamethylene] carbonate diol is a copolymer of 1,4-cyclohexanedimethanol and 1,6-hexanediol with dialkyl carbonate.

As the polycarbonate polyol, a poly[cyclohexylene bis(methylene)/hexamethylene] carbonate diol is preferable. Examples of commercial products of the poly[cyclohexylene bis(methylene)/hexamethylene] carbonate diol include ETERNACOLL (registered trademark) UM-90 manufactured by Ube Industries, Ltd.

The content of the polycarbonate polyol in the polyol (P) is preferably 0.1% by mass or more, more preferably 10% by mass or more, and further preferably 30% by mass or more. On the other hand, the content of the polycarbonate polyol in the polyol (P) is preferably 90% by mass or less, more preferably 80% by mass or less, and further preferably 70% by mass or less.

As the polyol (P), a (meth)acrylic polyol, a polyether polyol, a polyester polyol, and a polycarbonate polyol are mentioned as described above. These may contain a fluorine atom, but it is preferable that the (meth)acrylic polyol contain a fluorine atom, and the polyether polyol, polyester polyol, and polycarbonate polyol contain no fluorine atom. As a result, the squeegee slidability of the surface protective layer can be improved.

The polyol (P) may be used alone or two or more kinds thereof may be used in combination. In a case where two or more kinds of the polyols (P) are used in combination, the combination of polyols (P) is preferably a combination of at least one of a polyether polyol, a polyester polyol, and a polycarbonate polyol with a (meth)acrylic polyol, and more preferably a combination of a (meth)acrylic polyol and a polyether polyol or a combination of a (meth)acrylic polyol and a polycarbonate polyol, from the viewpoint of stretchability of the multilayer film. In addition, from the viewpoint of scratch resistance of the surface protective layer, a combination of a (meth)acrylic polyol and a polyether polyol or a combination of a (meth)acrylic polyol and a polyester polyol is more preferable.

(Polyisocyanate (I))

The polyurethane contained in the surface protective layer is obtained by reacting the above-mentioned polyol (P) with a polyisocyanate (I).

It is preferable that the polyisocyanate (I) have no aromatic ring in the molecule. The polyisocyanate (I) having no aromatic ring in the molecule can impart excellent weather resistance to the surface protective layer. This makes it possible to reduce yellowing of the surface protective layer over time.

Examples of the polyisocyanate (I) include polyisocyanates such as an aliphatic polyisocyanate and a polyisocyanate having an alicyclic structure.

Examples of the aliphatic polyisocyanate include ethylenediisocyanate, tetramethylenediisocyanate, hexamethylenediisocyanate, dodecamethylenediisocyanate, 1,6,11-undecantriisocyanate, 2,2,4-trimethylhexamethylenediisocyanate, 2,6-diisocyanatomethyl caproate, bis(2-isocyanatoethyl) phmalate, bis(2-isocyanatoethyl) carbonate, and 2-isocyanatoethyl-2,6-diisocyanatohexanoate.

Examples of the polyisocyanate having an alicyclic structure include 4,4′-dicyclohexylmethane diisocyanate (hydrogenated MDI), isophorone diisocyanate, methylcyclohexylene diisocyanate (hydrogenated TDI), and 1,3-bis(isocyanatomethyl) cyclohexane (hydrogenated m-XDI).

As the polyisocyanate (I), derivatives of the above-mentioned polyisocyanate are also mentioned. Examples of the derivatives of polyisocyanate include multimers of the polyisocyanate described above (for example, a dimer, a trimer (for example, an isocyanurate modified product, and an iminoxadiazinedione modified product), a pentamer, a heptamar, etc.), an allophanate modified product (for example, an allophanate modified product generated by reaction of the polyisocyanate described above with a low molecular weight polyol), a polyol modified product (for example, a polyol modified product (alcohol adduct) generated by reaction of the polyisocyanate described above with a low molecular weight polyol), a biuret modified product (for example, a biuret modified product generated by reaction of the polyisocyanate described above with amines), a compound generated by reaction of the polyisocyanate described above with water, an urea modified product (for example, an urea modified product generated by reaction of the polyisocyanate described above with diamines), an oxadiazine trion modified product (for example, an oxadiazine trion generated by reaction of the polyisocyanate described above with carbon dioxide), a carbodiimide modified product (a carbodiimide modified product generated by the decarboxylation condensation reaction of the polyisocyanate described above, and the like), a uretdione modified product, and a uretonimine modified product. As the low molecular weight polyol used in the reaction with the polyisocyanate, the same compounds as the low molecular weight polyol described above in the polyester polyol are mentioned. The polyisocyanate (I) may be used alone or two or more kinds thereof may be used in combination.

As the polyisocyanate (I), a polyisocyanate derivative is preferably mentioned, and a biuret modified product of hexamethylene diisocyanate is more preferably mentioned. Examples of the commercial products of the biuret modified product of hexamethylene diisocyanate include a product of which the trade name is “TAKENATE (registered product) D-165N” manufactured by Mitsui Chemicals Co., Ltd.

The equivalent ratio (isocyanate group/hydroxyl group) of the isocyanate group in the polyisocyanate (I) to the hydroxyl group in the polyol (P) in the monomer used as the raw material of the polyurethane is preferably 0.8 to 1.2, and more preferably 0.9 to 1.1. The equivalent ratio (isocyanate group/hydroxyl group) set to 0.8 or more can improve the scratch resistance of the surface protective layer. In addition, the equivalent ratio (isocyanate group/hydroxyl group) set to 1.2 or less can improve the water resistance of the surface protective layer.

The equivalent ratio (isocyanate group/hydroxyl group) of the isocyanate group in the polyisocyanate (I) to the hydroxyl group in the polyol (P) is obtained by dividing the number of isocyanate groups in the polyisocyanate (I) by the number of hydroxyl groups in the polyol (P).

The number of hydroxyl groups in the polyol (P) is calculated on the basis of the following formula. The hydroxyl value refers to a value obtained by measurement in accordance with the 4.2 B method of “Plastics—Polyols for use in the production of polyurethane—Part 1: Determination of hydroxyl number” in JIS K 1557-1: 2007 (ISO 14900:2001).

Number of hydroxyl groups in polyol (P)=Content (g) of polyol (P)×hydroxyl value/56100

The number of isocyanate groups in the polyisocyanate (I) is calculated on the basis of the following formula. The isocyanate equivalent refers to a value obtained by dividing the molecular weight of the polyisocyanate (I) by the number of the isocyanate group per molecule. Specifically, it refers to a value measured in accordance with JIS K1603.

Number of isocyanate groups in the polyisocyanate (I)=Content (g) of polyisocyanate (I)/isocyanate equivalent (Polythiol (T))

It is preferable that the polyurethane contained in the surface protective layer further contain a polythiol (T) unit. That is, it is preferable that the polyurethane be a reaction product of the polyol (P), the polyisocyanate (I), and a polythiol (T). The use of the polythiol (T) may improve the scratch resistance of the surface protective layer and the stretchability of the multilayer film.

It is preferable that the polythiol (T) have no aromatic ring in the molecule. The polythiol (T) having no aromatic ring in the molecule can impart excellent weather resistance to the surface protective layer. This makes it possible to reduce yellowing of the surface protective layer over time.

The polythiol (T) only needs to have two or more thiol groups (—SH) in the molecule, and it is preferable that the polythiol (T) have three or more thiol groups in the molecule. Examples of the polythiol (T) include ethylene glycol dimercaptopropionate, trimethylolpropanetris(3-mercaptopropionate), pentaerythritol tetrakis(mercaptopropionate), dipentaerythritol hexakis(3-mercaptopropionate), and tris(mercaptopropionyloxyethyl) isocynurate. Among these, trimethylolpropane tris(3-mercaptopropionate) is preferable. The polythiol (T) may be used alone or two or more kinds thereof may be used in combination.

In a case where the polyurethane contains the polythiol (T) unit, the equivalent ratio of the isocyanate group in the polyisocyanate (I) to the hydroxyl group in the polyol (P) and the thiol group in the polythiol (T), [the isocyanate group/(the hydroxyl group+the thiol group)], in the monomer used as the raw material of the polyurethane is preferably 0.8 to 1.2, and more preferably 0.9 to 1.1. The equivalent ratio [the isocyanate group/(the hydroxyl group30 the thiol group)] set to 0.8 or more can improve the scratch resistance of the surface protective layer. The equivalent ratio [the isocyanate group/(the hydroxyl group+the thiol group)] set to 1.2 or less can improve the water resistance of the surface protective layer.

The equivalent ratio of the isocyanate group in the polyisocyanate (I) to the hydroxyl group in the polyol (P) and the thiol group in the polythiol (T), [the isocyanate group/(the hydroxyl group+the thiol group)], is determined by dividing the number of the isocyanate group in the polyisocyanate (I) by the total number of the number of the hydroxyl group in the polyol (P) and the number of the thiol group in the polythiol (T).

The number of the hydroxyl group in the polyol (P) and the number of the isocyanate group in the polyisocyanate (I) can be determined in the same manner as that described above.

The multilayer film of the present invention includes the surface protective layer containing the polyurethane mentioned above. The thickness of the surface protective layer is preferably 1 to 50 μm, and more preferably 5 to 30 μm. The surface protective layer having the thickness set to 1 μm or more can improve the scratch resistance. In addition, the surface protective layer having the thickness set to 50 μm or less can reduce the occurrence of appearance defects.

[Substrate Layer]

The multilayer film of the present invention includes the substrate layer. It is preferable that the substrate layer contain at least one of a thermoplastic resin and a thermoplastic elastomer. This can improve the stretchability of the multilayer film.

Examples of the thermoplastic resin include a polyurethane resin, a polyolefin resin, a polyester resin, a polyamide resin, a polyvinyl resin, and a polycarbonate resin. Examples of the thermoplastic elastomer include a polyurethane thermoplastic elastomer, a styrene thermoplastic elastomer, an acrylic thermoplastic elastomer, a polyolefin thermoplastic elastomer, a polyvinyl chloride thermoplastic elastomer, a polyester thermoplastic elastomer, and a polyamide thermoplastic elastomer. Each of the thermoplastic resin and thermoplastic elastomer may be used alone or two or more kinds thereof may be used in combination.

Examples of the polyurethane resin include a polyester-based polyurethane resin. Examples of the polyester-based polyurethane resin include a reaction product of a polyisocyanate and a polyester polyol. Examples of the polyurethane thermoplastic elastomer include a polyester-based polyurethane thermoplastic elastomer. Examples of the polyester-based polyurethane thermoplastic elastomer include a reaction product of a polyisocyanate, a polyester polyol, and a chain extender. As the chain extender, a low molecular weight polyol having two or more hydroxyl groups and having a molecular weight of less than 400 is mentioned, and specific examples thereof include the same low molecular weight polyols as described above for the polyester polyol in the polyol (P).

Among these, the substrate layer preferably contains a thermoplastic resin, more preferably contains a polyurethane resin, and further preferably contains a polyester-based polyurethane resin. The substrate layer preferably contains a thermoplastic elastomer, more preferably contains a polyurethane thermoplastic elastomer, and further preferably contains a polyester-based polyurethane thermoplastic elastomer. The thickness of the substrate layer is not particularly limited, and may be 10 to 300 μm, and preferably 20 to 200 μm.

[Adhesive Layer]

The multilayer film of the present invention includes an adhesive layer integrally laminated on the second surface of the substrate layer. The thickness of the adhesive layer is not particularly limited, but is preferably 10 to 200 μm, and more preferably 20 to 100 μm.

The adhesive layer contains an adhesive agent. The adhesive agent is not particularly limited, and examples thereof include an acryl-based adhesive agent, a rubber-based adhesive agent, a vinyl alkyl ether-based adhesive agent, a silicone-based adhesive agent, a polyester-based adhesive agent, a polyamide-based adhesive agent, a polyurethane-based adhesive agent, a fluorine-based adhesive agent, and an epoxy-based adhesive agent. An acryl-based adhesive agent is preferable. The adhesive agent may be used alone or two or more kinds thereof may be used in combination.

Further, the adhesive layer may contain an additive, as needed. Examples of the additive include a tackifier, such as a rosin derivative resin, a polyterpene resin, a petroleum resin, and an oil-soluble phenolic resin, a plasticizer, a filler, an antiaging agent, an antioxidant, and a colorant such as a pigment like carbon black and a dye. The adhesive agent may be crosslinked by a general-purpose crosslinking agent such as an aziridine-based crosslinking agent, an epoxy-based crosslinking agent, or an isocyanate-based crosslinking agent.

The formation of the adhesive layer is not particularly limited, but is performed by applying an adhesive agent composition including an adhesive agent and, if necessary, an additive and a cross-linking agent to the second surface of the substrate layer and drying the same. As a result, an adhesive layer integrally laminated on the second surface of the base material layer is formed.

[Metallic Brilliant Layer]

The multilayer film of the present invention may further include a metal brilliant layer. The multilayer film including the metallic brilliant layer can exhibit a glare property and decorate a surface of an article such as an automobile in a metallic tone.

The metallic brilliant layer is not particularly limited, but only needs to be disposed on at least one of the first surface and the second surface of the substrate layer. An anchor coat layer may be further disposed, as needed, between the metallic brilliant layer and a layer adjacent to the metallic brilliant layer.

In a case where the metallic brilliant layer is integrally laminated on the first surface of the substrate layer in the multilayer film, it is preferable that the metallic brilliant layer be included between the substrate layer and the surface protective layer. In this case, the multilayer film includes the substrate layer, the metallic brilliant layer integrally laminated on the first surface of the substrate layer by intermediary of the anchor coat layer as needed, and the surface protective layer integrally laminated on the metallic brilliant layer by intermediary of the anchor coat layer as needed.

Further, in a case where the metallic brilliant layer is integrally laminated on the second surface of the substrate layer in the multilayer film, it is preferable that the metallic brilliant layer be included between the substrate layer and the adhesive layer. In this case, the multilayer film includes the substrate layer, the metallic brilliant layer integrally laminated on the second surface of the substrate layer by intermediary of the anchor coat layer as needed, and the adhesive layer integrally laminated on the metallic brilliant layer by intermediary of the anchor coat layer as needed.

It is preferable that the metallic brilliant layer include metal. Examples of the metal include copper, nickel, chromium, titanium, cobalt, molybdenum, zirconium, tungsten, palladium, indium, tin, gold, silver, and aluminum. Among these, indium and aluminum are preferable. The metal described above may be used alone or two or more kinds thereof may be used in combination.

The thickness of the metallic brilliant layer is preferably 1 nm to 100 nm, and more preferably 1.5 nm to 7.5 nm. The metallic brilliant layer having the thickness set to 1 nm or more can improve the glare property. Further, the metallic brilliant layer having the thickness set to 100 nm or less can reduce excessive hardening of the metallic brilliant layer and thereby reduce the occurrence of a crack.

As a method for forming the metallic brilliant layer, a known method such as a metal deposition method is used. Examples of the metal deposition method include a physical vapor deposition method (PVD method) such as a vacuum deposition method, a sputtering method, and an ion plating method, and a chemical vapor deposition method (CVD method).

The anchor coat layer is used to improve adhesion between the metallic brilliant layer and a layer adjacent to the metallic brilliant layer. It is preferable that the anchor coat layer include an anchor coat agent. Examples of the anchor coat agent include a polyester-based resin, a melamine-based resin, a urea-based resin, a urea/melamine-based resin, a urethane-based resin, an acrylic resin, and a nitrocellulose-based resin. These anchor coat agents may be used alone or two or more kinds thereof may be used in combination. The thickness of the anchor coat layer is not particularly limited as long as it is from 0.01 to 1 μm.

The multilayer film of the present invention is preferably used for protecting a surface of an article such as a transportation vehicle including an automobile, a train, and an airplane, glass, a building, and a signboard. The multilayer film adhesively integrated with the article surface using the adhesive layer can protect the article surface from a dirt and a scratch, which makes it possible to maintain the appearance for a long period of time.

In particular, the multilayer film of the present invention can be suitably used as an automobile protective film for protecting a surface of an automobile. For example, the multilayer film can be used by being adhesively integrated with a coated surface of the automobile by intermediary of the adhesive layer. This can reduce the occurrence of a scratch on the multilayer film caused by contact or collision of a flying object such as a pebble and a sand dust during traveling of the automobile. Further, the multilayer film can reduce the occurrence of the water spot even when water is adhered to the multilayer film by rainfall, washing, or the like. Thus, the multilayer film can beautifully maintain the surface of the automobile for a long period of time.

[Two-Liquid Curable Coating Agent]

The two-liquid curable coating agent of the present invention include a main agent including a polyol (P) having a hydroxyl value of 25 to 380 mgKOH/g and a content of fluorine atoms of 0.01 to 20% by mass, and a curing agent including a polyisocyanate (I). The two-liquid curable coating agent is preferably used for forming the surface protective layer included in the multilayer film described above.

As the polyol (P) and the polyisocyanate (I) in the two-liquid curable coating agent, the same polyol (P) and polyisocyanate (I) described in the surface protective layer can be respectively used. Further, an equivalent ratio of isocyanate groups in the polyisocyanate (I) with respect to hydroxyl groups in the polyol (P), (isocyanate group/hydroxyl group), in the two-liquid curable coating agent is preferably the same as the equivalent ratio (isocyanate group/hydroxyl group) described above in the surface protective layer.

It is preferable that the main agent of the two-liquid curable coating agent further include a polythiol (T). As the polythiol (T) in the main agent of the two-liquid curable coating agent, the same polythiol (T) described above in the surface protective layer can be used. Further, an equivalent ratio of isocyanate groups in the polyisocyanate (I) with respect to hydroxyl groups in the polyol (P) and thiol groups in the polythiol (T), [isocyanate group/(hydroxyl group+thiol group)], in the two-liquid curable coating agent is preferably the same as the equivalent ratio [isocyanate group/(hydroxyl group+thiol group)] described above in the surface protective layer.

It is preferable that the main agent of the two-liquid curable coating agent include a curing catalyst. Examples of the curing catalyst include an organometallic compound such as dibutyltin oxide, tin 2-ethylcaproate, tin octylate, and dibutyltin dilaurate. The curing catalyst may be used alone or two or more kinds thereof may be used in combination.

The main agent and the curing agent of the two-liquid curable coating agent may include an additive as needed in a range in which physical properties of the two-liquid curable coating agent are not impaired. Examples of the additive include an antioxidant, a light stabilizer, a heat stabilizer, an antistatic agent, and a defoaming agent.

The main agent and the curing agent of the two-liquid curable coating agent may include a solvent. In a case where the main agent of the two-liquid curable coating agent includes a solvent, the solid content concentration of the main agent is preferably 10 to 90% by mass, and more preferably 20 to 80% by mass. In a case where the curing agent of the two-liquid curable coating agent include a solvent, the solid content concentration of the curing agent is preferably 10 to 90% by mass, and more preferably 20 to 80% by mass.

Examples of the solvent include hydrocarbons such as pentane, hexane, heptane, and cyclohexane; ketones such as acetone, methyl ethyl ketone, methyl isobutyl ketone, and cyclohexanone; and esters such as ethyl acetate and butyl acetate. The solvent may be used alone or two or more kinds thereof may be used in combination.

As a method for using the two-liquid curable coating agent, first, the curing agent is mixed to the main agent of the two-liquid curable coating agent and the resulting two-liquid curable coating agent is applied to the substrate layer. It is preferable that the curing agent be mixed to the main agent of the two-liquid curable coating agent immediately before the two-liquid curable coating agent is applied to the substrate. Note that, as the substrate layer, the substrate layer included in the multilayer film described above is used.

Examples of a method for applying the two-liquid curable coating agent to the substrate layer include an application method such as a dip coating method, a spray coating method, a roll coating method, a doctor blade method, and a screen printing method, and casting using, for example, a bar coater and an applicator.

The two-liquid curable coating agent applied onto the substrate layer is then subjected to heat curing by heating. The polyol (P) and the polyisocyanate (I) included in the two-liquid curable coating agent are reacted to form polyurethane by heating. As a result, the two-liquid curable coating agent is cured and forms the surface protective layer.

The temperature of the heat curing of the two-liquid curable coating agent is preferably 60 to 180° C., and more preferably 80 to 150° C. The time of the heat curing of the two-liquid curable coating agent is preferably 1 to 30 minutes, and more preferably 1 to 10 minutes.

As described above, the surface protective layer that is integrally laminated on the first surface of the substrate layer can be formed by mixing the curing agent to the main agent of the two-liquid curable coating agent and applying the two-liquid curable coating agent to the first surface of the substrate layer.

Further, although the two-liquid curable coating agent is preferably used for forming the surface protective layer included in the multilayer film described above, usage of the two-liquid curable coating agent is not limited thereto. For example, the two-liquid curable coating agent can be directly applied to an article surface to form the surface protective layer on the article surface. The surface protective layer formed in this manner is integrally laminated on the article surface without the intermediary of the adhesive layer or the substrate layer. The article surface can also be protected by such a surface protective layer. Note that the article is not particularly limited, and examples of the article include a transportation vehicle such as an automobile, a train, and an airplane, glass, a building, and a signboard.

Note that, as a method for forming the surface protective layer directly on the article surface, the method for using the two-liquid curable coating agent described above may be performed in the same manner except that the two-liquid curable coating agent is applied to the article instead of the substrate layer. Further, the surface protective layer integrally laminated on the article surface without the intermediary of the adhesive layer or the substrate layer is the same as the surface protective layer included in the multilayer film described above, and thus the detailed description thereof is omitted here.

### Advantageous Effects of Invention

According to the present invention, there can be provided the surface protective layer excellent in the water spot resistance and the scratch resistance. Thus, it becomes possible to beautifully maintain the appearance of an article surface, to which the surface protective layer is applied, for a long period of time.

Further, in the surface protective layer, the water spot resistance is improved without reducing the squeegee slidability. Thus, when the multilayer film including the surface protective layer is adhered to the article surface using a squeegee, the squeegee can be pressed and slid on the surface protective layer without being caught. Thus, the multilayer film can be adhesively integrated with the article surface without having a scratch.

Further, the multilayer film, which is flexible and excellent in stretchability, can resist the tensile force by the squeegee at the time of adhering the multilayer film to the article surface, which makes it possible to reduce the occurrence of tear in the multilayer film.

### BRIEF DESCRIPTION OF DRAWINGS

FIG. 1 is a diagram for explaining a contact angle in the present invention.

### DESCRIPTION OF EMBODIMENTS

Hereinafter, the present invention will be described in detail by way of Examples without being limited thereto.

[Synthesis of (meth)acryl polyol]

### SYNTHETIC EXAMPLE 1

As a solvent, 233 parts by mass of methyl ethyl ketone (MEK) was charged in a reaction vessel and heated to 60° C. Next, 4.0 parts by mass of azobis-2-methylbromonitrile (ABN-E, manufactured by Japan Hydrazine Co., Inc.) as a polymerization catalyst was mixed, by stirring, to a monomer composition including 57 parts by mass of methyl methacrylate (MMA), 16.2 parts by mass of n-butyl acrylate (n-BA), 25.9 parts by mass of 2-hydroxyethyl acrylate (2-HEA), and 0.9 parts by mass of 2-(perfluorohexyl)ethyl acrylate (FAAC-6) to prepare a monomer mixed liquid. The monomer mixed liquid thus obtained was added dropwise to the solvent described above over a period of 3 hours, and the reaction was terminated after additional 3 hours. In this manner, a (meth)acryl polyol solution (solid content of 30% by mass) including a (meth)acryl polyol (hydroxyl value of 125 mgKOH/g and fluorine atom content of 0.5% by mass) was obtained.

### SYNTHETIC EXAMPLES 2 TO 20

(Meth)acryl polyol solutions (solid contents of 30% by mass) including (meth)acryl polyols were obtained in the same manner as in Synthetic example 1 except that monomer compositions including, in formulation amounts indicated in Tables 1 and 2, 2-(perfluorohexyl)ethyl acrylate, 2-hydroxyethyl acrylate, 2-hydroxyethyl methacrylate, α-butyl-ω-(3-methacryloxypropyl)polydimethylsiloxane (weight-average molecular weight (Mw) 1,000, manufactured by JNC Corp., trade name “Silaplane FM-0711”), methyl methacrylate, isobornyl methacrylate, and n-butyl acrylate, respectively, were used.

### EXAMPLES 1 TO 22 AND COMPARATIVE EXAMPLES 1 TO 3

Two-liquid curable coating agents including main agents and curing agents described below were prepared. The main agents (solid contents of 40% by mass) were obtained by supplying, in formulation amounts indicated in Tables 3 and 4, the (meth)acryl polyols obtained in Synthetic examples 1 to 20, a polyether polyol (polytetramethylene glycol, manufactured by Mitsubishi Chemical Corp., PTMG650), a polyester polyol (polycaprolactone triol, manufactured by Daicel Corp., PLACCEL 303), a polycarbonate polyol (poly[cyclohexylene bis (methylene)/hexamethylene]carbonate diol, manufactured by UBE Industries, Ltd., ETERNACOLL (registered trademark) UM-90), a polythiol (T) (trimethylolpropane tris(3-mercaptopropionate)), as well as dibutyltin dilaurate as a curing catalyst and methyl isobutyl ketone, to a reaction vessel and mixing them together.

Note that, as for the (meth)acryl polyols obtained in Synthetic examples 1 to 20, a (meth)acryl polyol solution including each of the (meth)acryl polyols was supplied to the reaction vessel so that the (meth)acryl polyol was adjusted to the formulation amount (solid content) indicated in Tables 3 and 4. Further, a mass ratio of the fluorine-containing (meth)acryl-based monomer (a1) units with respect to the hydroxyl group-containing (meth)acryl-based monomer (a2) units, [the mass of the fluorine-containing (meth)acryl-based monomer (a1) unit/the mass of the hydroxyl group-containing (meth)acryl-based monomer (a2) unit], in each (meth)acryl polyol used in Examples 1 to 22 and Comparative example 1 to 3 is indicated in the column “Mass ratio [(a1)/(a2)]” in Tables 3 and 4. Further, fluorine atom contents (⁹.5 by mass) and hydroxyl values (mgOH/g) of the polyols (P), which include the (meth)acryl polyols obtained in Synthetic examples 1 to 20, the polyether polyol, the polyester polyol, and the polycarbonate polyol in the formulation amounts indicated in Tables 3 and 4, respectively, in Examples 1 to 22 and Comparative examples 1 to 3 are indicated in Tables 3 and 4.

Next, the curing agents including the polyisocyanate (I) (biuret modified product of hexamethylene diisocyanate, content of isocyanate groups: 23.3%, manufactured by Mitsui Chemicals, Inc., TAKENATE D165N) and methyl isobutyl ketone in formulation amounts (in terms of solid content for polyisocyanate (I)) indicated in Tables 3 and 4, respectively, were prepared. The curing agents were added to and mixed with the main agents. Subsequently, the resulting two-liquid curable coating agents were each immediately applied onto the first surface of the substrate layer (sheet including a polyurethane thermoplastic elastomer, manufactured by Nihon Matai Co., Ltd., ESMER URS) using a bar coater (No. 16). The applied two-liquid curable coating agent was then heated at 120° C. for 10 minutes to remove the solvent and perform heat curing, so that the surface protective layer (thickness of 10 μm) integrally laminated on the first surface of the substrate layer was formed.

Next, an adhesive composition was obtained by mixing 100 parts by mass of an acryl-based adhesive (manufactured by Harima Chemicals Group, Inc., HARIACRON 560CH) and 0.5 parts by mass of an isocyanate-based crosslinking agent (manufactured by TOSOH Corp., Coronate (registered trademark) L-45E). Subsequently, the adhesive composition was immediately applied to the second surface of the substrate layer using a bar coater (No. 24) to obtain a coated film. This coated film was heated at 100° C. for 3 minutes to remove the solvent. After heating, a release paper was laminated on the coated film by slowly rolling a roller (weight of 10 kg) around which the release paper had been wound on the roller. The coated film was then cured at 40° C. for 3 days to form the adhesive layer (thickness of 25 μm) on the second surface of the substrate layer. In this manner, the multilayer film including the substrate layer, the surface protective layer integrally laminated on the first surface of the substrate layer, and the adhesive layer integrally laminated on the second surface of the substrate layer was obtained.

Note that the term “equivalent ratio” described in Tables 3 and 4 refers to an “equivalent ratio (isocyanate group/hydroxyl group) of isocyanate groups in the polyisocyanate (I) with respect to hydroxyl groups in the polyol (P)” in Examples 1 to 7 and 9 to 22 and Comparative examples 1 to 3, while the term “equivalent ratio” refers to an “equivalent ratio [isocyanate group/(hydroxyl group ₊thiol group)] of isocyanate groups in the polyisocyanate (I) with respect to hydroxyl groups in the polyol (P) and thiol groups in the polythiol (T)” in Example 8.

[Evaluations]

The multilayer films produced in Examples 1 to 22 and Comparative examples 1 to 3 were evaluated in the water spot resistance, the scratch resistance, the slidability of squeegee, and the stretchability in accordance with the following procedures. The results are shown in Tables 3 and 4.

(Water Spot Resistance)

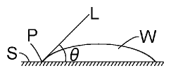

The multilayer film was horizontally disposed with the surface protective layer facing upward. Under the atmosphere at a temperature of 23° C. and a relative humidity of 50%, one drop of 2 μ1 water droplet was dropped on the surface protective layer of the multilayer film and a contact angel (°) was measured 1 second and 300 seconds after the dropping of the water droplet using a contact angle meter (manufactured by Kyowa Interface Science Co. Ltd., DM-501). A change rate (%) of the contact angle was calculated on the basis of a formula [change rate (%) of contact angle=100×(contact angle after 1 second−contact angle after 300 seconds)/(contact angle after 1 second)]. Note that the term “contact angle” refers to an angle θ at the side of a water droplet W out of angles formed by a tangential line L of the water droplet W at an end point P of the interface between the water droplet W and a surface protective layer S, and the surface of the surface protective layer S, as shown in FIG. 1.

The contact angle after 1 second (also simply referred to as “initial contact angle”) and the change rate of the contact angle are shown in Tables 3 and 4. As described above, it is considered that both the water repellency (initial water repelling property) and the hydrophilicity of the surface protective layer contribute to the water spot resistance of the surface protective layer. Thus, the “contact angle after one second” was scored in accordance with the following evaluation criteria (A) and the “change rate of contact angle” was scored in accordance with the following evaluation criteria (B). These scores are shown in Tables 3 and 4. Further, the total score of the score of the “contact angle after one second” and the score of the “change rate of contact angle” is shown in the column “Overall evaluation” of the water spot resistance in Tables 3 and 4. Note that, between the water repellency (initial water repelling property) and the hydrophilicity of the surface protective layer, the hydrophilicity is thought to contribute more to the water spot resistance of the surface protective layer. Thus, in the following evaluation criteria, the change rate of the contact angle was given the higher score than the contact angle after 1 second.

Evaluation criteria (A): contact angle after 1 second

1 point: contact angle after 1 second of 82° or more and less than 90°

2 points: contact angle after 1 second of 90° or more and less than 98°

3 points: contact angle after 1 second of 98° or more and less than 106°

4 points: contact angle after 1 second of 106° or more

Evaluation criteria (B): change rate of contact angle

8 points: change rate of contact angle of 14% or more

7 points: change rate of contact angle of 13% or more and less than 14%

6 points: change rate of contact angle of 12% or more and less than 13%

5 points: change rate of contact angle of 11% or more and less than 12%

4 points: change rate of contact angle of 10% or more and less than 11%

3 points: change rate of contact angle of 9% or more and less than 10%

2 points: change rate of contact angle of 8% or more and less than 9%

1 point: change rate of contact angle of 7% or more and less than 8%

0 points: change rate of contact angle of less than 7%

(Scratch Resistance)

A glass plate was horizontally disposed. After removing the release paper from the adhesive layer of the multilayer film, the multilayer film was placed on the glass plate so that the adhesive layer came into contact with the glass plate. Then, a squeegee (manufactured by MIRAREED, PRO Big gum spatula) was slid in a reciprocating manner on the surface protective layer 10 times by hand while a load of 0.3 N is applied to the squeegee, and the number of scratches generated on the surface protective layer by this operation was counted.

(Slidability of Squeegee)

A glass plate was horizontally disposed. After removing the release paper from the adhesive layer of the multilayer film, the multilayer film was placed on the glass plate so that the adhesive layer came into contact with the glass plate. Then, the multilayer film was adhered to the glass plate by pressing and sliding the squeegee (manufactured by MIRAREED, PRO Big gum spatula) on the surface protective layer. Resistance feeling obtained by pressing and sliding the squeegee on the surface protective layer was evaluated in accordance with the following criteria.

A: no resistance feeling

B: slight resistance feeling

C: some resistance feeling

D: strong resistance feeling, unable to slide squeegee on surface protective layer

(Stretchability)

In accordance with JIS K 7127 (Plastics—Determination of tensile properties), the multilayer film was cut in a shape of test piece type 2 and a stretch rate (%) of the multilayer film was measured under the condition of a tension rate of 100 mm/min using a tensile testing machine (manufactured by SHIMADZU Corp., Autograph AGS-X).

TABLE 1

| | | | Synthetic examples | | | | | | |
|---|---|---|---|---|---|---|---|---|---|
| | | | 1 | 2 | 3 | 4 | 5 | 6 | 7 |
| Formulation | Fluorine-containing | 2-(Perfluorohexyl)ethyl acrylate | 0.90 | 1.8 | 1.8 | 1.8 | 42.3 | 1.8 | 0 |
| (parts by mass) | (meth)acryl-based monomer (a1) | | | | | | | | |
| | Hydroxyl group-containing | 2-Hydroxyethyl acrylate | 25.9 | 25.9 | 5.2 | 48.2 | 0 | 0 | 25.9 |
| | (meth)acryl-based monomer (a2) | 2-Hydroxyethyl methacrylate | 0 | 0 | 0 | 34 | 5.8 | 0 | 0 |
| | Other (meth)acryl-based | Methyl methacrylate | 57 | 57 | 64 | 0 | 0 | 0 | 57 |
| | monomers (a4) | Isobornyl methacrylate | 0 | 0 | 0 | 16 | 51.9 | 64 | 0 |
| | | n-Butyl acrylate | 16.2 | 15.3 | 29 | 0 | 0 | 34.2 | 17.1 |

| | | | | | | | |
|---|---|---|---|---|---|---|---|
| Total of monomers | 100 | 100 | 100 | 100 | 100 | 100 | 100 |

| | | | | | | | |
|---|---|---|---|---|---|---|---|
| Mass ratio [fluorine-containing(meth)acryl-based monomer (a1)/hydroxyl | 0.035 | 0.069 | 0.35 | 0.022 | 7.3 | — | 0 |
| group-containing (meth)acryacryl-based monomer (a2)] | | | | | | | |

TABLE 2

| | | | Synthetic examples | | | | | | |
|---|---|---|---|---|---|---|---|---|---|
| | | | 8 | 9 | 10 | 11 | 12 | 13 | 14 |
| Formulation | Fluorine-containing | 2-(Perfluorohexyl)ethyl acrylate | 1.8 | 1.8 | 17 | 26 | 1.8 | 1.8 | 1.8 |
| (parts by | (meth)acryl-based monomer | | | | | | | | |
| mass) | (a1) | | | | | | | | |
| | Hydroxyl group-containing | 2-Hydroxyethyl acrylate | 0 | 0 | 0 | 0 | 25.9 | 12.5 | 16.5 |
| | (meth)acryl-based monomer | 2-Hydroxyethyl methacrylate | 58 | 46 | 29 | 29 | 0 | 0 | 0 |
| | (a2) | | | | | | | | |
| | Siloxane bond-containing | a-butyl-w-(3- | 0 | 0 | 0 | 0 | 20 | 0 | 0 |
| | (meth)acryl-based monomer | methacryloxypropyl)polydimethyl- | | | | | | | |
| | (a3) | siloxane | | | | | | | |
| | Other (meth)acryl-based | Methyl methacrylate | 0 | 0 | 0 | 0 | 31.0 | 61.7 | 60 |
| | monomers (a4) | Isobornyl methacrylate | 17 | 24 | 35 | 35 | 0 | 0 | 0 |
| | | n-Butyl acrylate | 23.2 | 28.2 | 19 | 10 | 21.3 | 24 | 21.7 |

| | | | | | | | |
|---|---|---|---|---|---|---|---|
| Total of monomers | 100 | 100 | 100 | 100 | 100 | 100 | 100 |

| | | | | | | | |
|---|---|---|---|---|---|---|---|
| Mass ratio [fluorine-containing(meth)acryl-based monomer (a1)/hydroxyl | 0.031 | 0.039 | 0.586 | 0.897 | 0.069 | 0.14 | 0.11 |
| group-containing (meth)acryl-based monomer (a2)] | | | | | | | |

| | | | Synthetic examples | | | | | |
|---|---|---|---|---|---|---|---|---|
| | | | 15 | 16 | 17 | 18 | 19 | 20 |
| Formulation | Fluorine-containing | 2-(Perfluorohexyl)ethyl acrylate | 0.20 | 0.10 | 1.8 | 1.8 | 1.8 | 1.8 |
| (parts by | (meth)acryl-based monomer | | | | | | | |
| mass) | (a1) | | | | | | | |
| | Hydroxyl group-containing | 2-Hydroxyethyl acrylate | 25.9 | 25.9 | 23.8 | 24.9 | 37.3 | 38.3 |
| | (meth)acryl-based monomer | 2-Hydroxyethyl methacrylate | 0 | 0 | 0 | 0 | 0 | 0 |
| | (a2) | | | | | | | |
| | Siloxane bond-containing | a-butyl-w-(3- | 0 | 0 | 0 | 0 | 0 | 0 |
| | (meth)acryl-based monomer | methacryloxypropyl)polydimethyl- | | | | | | |
| | (a3) | siloxane | | | | | | |
| | Other (meth)acryl-based | Methyl methacrylate | 57.0 | 57.0 | 57.0 | 57.0 | 52.0 | 51.0 |
| | monomers (a4) | Isobornyl methacrylate | 0 | 0 | 0 | 0 | 0 | 0 |
| | | n-Butyl acrylate | 16.9 | 16.9 | 17.4 | 16.3 | 8.9 | 8.9 |

| | | | | | | |
|---|---|---|---|---|---|---|
| Total of monomers | 100 | 100 | 100 | 100 | 100 | 100 |

| | | | | | | |
|---|---|---|---|---|---|---|
| Mass ratio [fluorine-containing(meth)acryl-based monomer (a1)/hydroxyl | 0.008 | 0.004 | 0.076 | 0.072 | 0.048 | 0.047 |
| group-containing (meth)acryl-based monomer (a2)] | | | | | | |

TABLE 3

| | | | | Examples | | | | | |
|---|---|---|---|---|---|---|---|---|---|
| | | | | 1 | 2 | 3 | 4 | 5 | 6 |
| Formulation | Polyol | (Meth)acryl | Synthetic example 1 | 100 | 0 | 0 | 0 | 50 | 50 |
| of main | (P) | polyol | Synthetic example 2 | 0 | 100 | 0 | 0 | 0 | 0 |
| agent | | (parts by | Synthetic example 3 | 0 | 0 | 100 | 0 | 0 | 0 |
| | | mass) | Synthetic example 4 | 0 | 0 | 0 | 100 | 0 | 0 |
| | | | Synthetic example 5 | 0 | 0 | 0 | 0 | 0 | 0 |
| | | | Synthetic example 6 | 0 | 0 | 0 | 0 | 0 | 0 |
| | | | Synthetic example 7 | 0 | 0 | 0 | 0 | 0 | 0 |
| | | | Mass ratio | 0.035 | 0.069 | 0.35 | 0.022 | 0.035 | 0.035 |
| | | | [(a1)/(a2)] | | | | | | |
| | | Other | Polyether polyol | 0 | 0 | 0 | 0 | 50 | 0 |
| | | polyols | Polyester polyol | 0 | 0 | 0 | 0 | 0 | 50 |
| | | (parts by | Polycarbonate polyol | 0 | 0 | 0 | 0 | 0 | 0 |
| | | mass) | | | | | | | |

| | | Fluorine atom content of polyol (P) | 0.50 | 1.0 | 1.0 | 1.0 | 0.25 | 0.25 |
|---|---|---|---|---|---|---|---|---|
| | | (parts by mass) | | | | | | |
| | | Hydroxyl value of polyol (P) (mgKOH/g) | 125 | 125 | 25 | 380 | 147.5 | 335 |
| | Polythiol (T) (parts by mass) | | 0 | 0 | 0 | 0 | 0 | 0 |
| | Dibutyltin dilaurate (parts by mass) | | 0.01 | 0.01 | 0.01 | 0.01 | 0.01 | 0.01 |
| | Methyl isobutyl ketone (parts by mass) | | 150 | 150 | 150 | 150 | 150 | 150 |
| Formulation | Polyisocyanate (I) (TAKENATE D165N) (parts by mass) | | 39 | 39 | 8 | 122 | 47 | 108 |
| of curing | Methyl isobutyl ketone (parts by mass) | | 59 | 59 | 12 | 183 | 71 | 162 |
| agent | | | | | | | | |
| Equivalent ratio [isocyanate group/hydroxyl group] or | | | 1 | 1 | 1 | 1 | 1 | 1 |
| [isocyanate group/(hydroxyl group + thiol group)] | | | | | | | | |
| Evaluation | Water | Contact angle after one second (°) | 91.8 | 92.0 | 92.0 | 86.8 | 88.7 | 82.3 |
| | spot | Score of contact angle after one second | 2 | 2 | 2 | 1 | 1 | 1 |
| | resistance | Change rate of contact angle (%) | 13.2% | 14.5% | 12.0% | 11.1% | 14.1% | 14.3% |
| | | Score of change rate of contact angle | 7 | 8 | 6 | 5 | 8 | 8 |
| | | Overall evaluation (Total score) | 9 | 10 | 8 | 6 | 9 | 9 |

| | | | | | | |
|---|---|---|---|---|---|---|
| Scratch resistance (Number of scratches) | 3 | 3 | 8 | 3 | 0 | 0 |
| Squeegee slidability | B | B | B | C | B | B |
| Stretch rate | 120% | 120% | 200% | 100% | 160% | 130% |

| | | | | Examples | | | Compartive Examples | | |
|---|---|---|---|---|---|---|---|---|---|
| | | | | 7 | 8 | 9 | 1 | 2 | 3 |
| Formulation | Polyol | (Meth)acryl | Synthetic example 1 | 50 | 50 | 0 | 0 | 0 | 0 |
| of main | (P) | polyol | Synthetic example 2 | 0 | 0 | 0 | 0 | 0 | 0 |
| agent | | (parts by | Synthetic example 3 | 0 | 0 | 0 | 0 | 0 | 0 |
| | | mass) | Synthetic example 4 | 0 | 0 | 0 | 0 | 0 | 0 |
| | | | Synthetic example 5 | 0 | 0 | 1 | 100 | 0 | 0 |
| | | | Synthetic example 5 | 0 | 0 | 0 | 0 | 100 | 0 |
| | | | Synthetic example 7 | 0 | 0 | 99 | 0 | 0 | 100 |
| | | | Mass ratio | 0.035 | 0.035 | 0.016 | 7.3 | — | 0 |
| | | | [(a1)/(a2)] | | | | | | |
| | | Other | Polyether polyol | 0 | 40 | 0 | 0 | 0 | 0 |
| | | polyols | Polyester polyol | 0 | 0 | 0 | 0 | 0 | 0 |
| | | (parts by | Polycarbonate polyol | 50 | 0 | 0 | 0 | 0 | 0 |
| | | mass) | | | | | | | |

| | | Fluorine atom content of polyol (P) | 0.25 | 0.25 | 0.25 | 25.0 | 1.0 | 0 |
|---|---|---|---|---|---|---|---|---|
| | | (parts by mass) | | | | | | |
| | | Hydroxyl value of polyol (P) (mgKOH/g) | 125 | 145 | 124 | 25 | 0 | 125 |
| | Polythiol (T) (parts by mass) | | 0 | 10 | 0 | 0 | 0 | 0 |
| | Dibutyltin dilaurate (parts by mass) | | 0.01 | 0.01 | 0.01 | 0.01 | 0.01 | 0.01 |
| | Methyl isobutyl ketone (parts by mass) | | 150 | 150 | 150 | 150 | 150 | 150 |
| Formulation | Polyisocyanate (I) (TAKENATE D165N) (parts by mass) | | 39 | 56 | 39 | 8 | 0 | 39 |
| of curing | Methyl isobutyl ketone (parts by mass) | | 59 | 84 | 59 | 12 | 0 | 59 |
| agent | | | | | | | | |
| Equivalent ratio [isocyanate group/hydroxyl group] or | | | 1 | 1.2 | 1 | 1 | 0 | 1 |
| [isocyanate group/(hydroxyl group + thiol group)] | | | | | | | | |
| Evaluation | Water | Contact angle after one second (°) | 85.1 | 88.3 | 101.0 | 106.3 | 103.2 | 89.0 |
| | spot | Score of contact angle after one second | 1 | 1 | 3 | 4 | 3 | 1 |
| | resistance | Change rate of contact angle (%) | 13.2% | 12.8% | 10.0% | 6.1% | 7.5% | 10.2% |
| | | Score of change rate of contact angle | 7 | 6 | 4 | 0 | 1 | 4 |
| | | Overall evaluation (Total score) | 8 | 7 | 7 | 4 | 4 | 5 |

| | | | | | | |
|---|---|---|---|---|---|---|
| Scratch resistance (Number of scratches) | 2 | 0 | 2 | 10 | 23 | 11 |
| Squeegee slidability | B | B | B | B | B | D |
| Stretch rate | 180% | 145% | 115% | 230% | 250% | 120% |

TABLE 4

| | | | | Examples | | | | | | |
|---|---|---|---|---|---|---|---|---|---|---|
| | | | | 10 | 11 | 12 | 13 | 14 | 15 | 16 |
| Formulation | Polyol | (Meth)acryl | Synthetic | 99 | 0 | 0 | 0 | 0 | 0 | 0 |
| of main | (P) | polyol | example 2 | | | | | | | |
| agent | | (parts by | Synthetic | 0 | 100 | 0 | 0 | 0 | 0 | 0 |
| | | mass) | example 8 | | | | | | | |
| | | | Synthetic | 0 | 0 | 100 | 0 | 0 | 0 | 0 |
| | | | example 9 | | | | | | | |
| | | | Synthetic | 0 | 0 | 0 | 100 | 0 | 0 | 0 |
| | | | example 10 | | | | | | | |
| | | | Synthetic | 0 | 0 | 0 | 0 | 100 | 0 | 0 |
| | | | example 11 | | | | | | | |
| | | | Synthetic | 1 | 0 | 0 | 0 | 0 | 0 | 0 |
| | | | example 12 | | | | | | | |
| | | | Synthetic | 0 | 0 | 0 | 0 | 0 | 100 | 0 |
| | | | example 13 | | | | | | | |
| | | | Synthetic | 0 | 0 | 0 | 0 | 0 | 0 | 100 |
| | | | example 14 | | | | | | | |
| | | | Synthetic | 0 | 0 | 0 | 0 | 0 | 0 | 0 |
| | | | example 15 | | | | | | | |
| | | | Synthetic | 0 | 0 | 0 | 0 | 0 | 0 | 0 |
| | | | example 16 | | | | | | | |
| | | | Synthetic | 0 | 0 | 0 | 0 | 0 | 0 | 0 |
| | | | example 17 | | | | | | | |
| | | | Synthetic | 0 | 0 | 0 | 0 | 0 | 0 | 0 |
| | | | example 18 | | | | | | | |
| | | | Synthetic | 0 | 0 | 0 | 0 | 0 | 0 | 0 |
| | | | example 19 | | | | | | | |
| | | | Synthetic | 0 | 0 | 0 | 0 | 0 | 0 | 0 |
| | | | example 20 | | | | | | | |
| | | | Mass ratio | 0.069 | 0.031 | 0.039 | 0.586 | 0.897 | 0.14 | 0.11 |
| | | | [(a1)/(a2)] | | | | | | | |
| | | Other | Polyether | 0 | 0 | 0 | 0 | 0 | 0 | 0 |
| | | polyols | polyol | | | | | | | |
| | | (parts by | Polyester | 0 | 0 | 0 | 0 | 0 | 0 | 0 |
| | | mass) | polyol | | | | | | | |
| | | | Polycarbonate | 0 | 0 | 0 | 0 | 0 | 0 | 0 |
| | | | polyol | | | | | | | |

| | | Fluorine atom content of polyol | 1.0 | 1.0 | 1.0 | 10.0 | 15.0 | 1.0 | 1.0 |
|---|---|---|---|---|---|---|---|---|---|
| | | (P) (parts by mass) | | | | | | | |
| | | Hydroxyl value of polyol (P) | 125 | 250 | 200 | 125 | 125 | 60 | 80 |
| | | (mgKOH/g) | | | | | | | |
| | Polythiol (T) (parts by mass) | | 0 | 0 | 0 | 0 | 0 | 0 | 0 |
| | Dibutyltin dilaurate (parts by mass) | | 0.01 | 0.01 | 0.01 | 0.01 | 0.01 | 0.01 | 0.01 |
| | Methyl isobutyl ketone (parts by | | 150 | 150 | 150 | 150 | 150 | 150 | 150 |
| | mass) | | | | | | | | |
| Formulation | Polyisocyanate (I) (TAKENATE D165N) | | 39 | 80 | 64 | 39 | 39 | 19 | 25 |
| of curing | (parts by mass) | | | | | | | | |
| agent | Methyl isobutyl ketone (parts by | | 59 | 120 | 96 | 59 | 59 | 29 | 38 |
| | mass) | | | | | | | | |
| Equivalent ratio [isocyanate group/hydroxyl group] | | | 1 | 1 | 1 | 1 | 1 | 1 | 1 |
| Evaluation | Water | Contact angle after one second (°) | 102.0 | 96.2 | 95.2 | 104.4 | 105.5 | 92.1 | 91.8 |
| | spot | Score of contact angle after one | 3 | 2 | 2 | 3 | 3 | 2 | 2 |
| | resistance | second | | | | | | | |
| | | Change rate of contact angle (%) | 11.0% | 11.4% | 12.0% | 10.5% | 9.6% | 12.2% | 13.0% |
| | | Score of change rate of contact angle | 5 | 5 | 6 | 4 | 3 | 6 | 7 |
| | | Overall evaluation (Total score) | 8 | 7 | 8 | 7 | 6 | 8 | 9 |

| | | | | | | | |
|---|---|---|---|---|---|---|---|
| Scratch resistance (Number of scratches) | 2 | 3 | 3 | 3 | 3 | 8 | 5 |
| Squeegee slidability | A | C | B | B | B | B | B |
| Stretch rate | 120% | 105% | 105% | 120% | 120% | 160% | 130% |

| | | | | Examples | | | | | |
|---|---|---|---|---|---|---|---|---|---|
| | | | | 17 | 18 | 19 | 20 | 21 | 22 |
| Formulation | Polyol | (Meth)acryl | Synthetic | 0 | 0 | 0 | 0 | 0 | 0 |
| of main | (P) | polyol | example 2 | | | | | | |
| agent | | (parts by | Synthetic | 0 | 0 | 0 | 0 | 0 | 0 |
| | | mass) | example 8 | | | | | | |
| | | | Synthetic | 0 | 0 | 0 | 0 | 0 | 0 |
| | | | example 9 | | | | | | |
| | | | Synthetic | 0 | 0 | 0 | 0 | 0 | 0 |
| | | | example 10 | | | | | | |
| | | | Synthetic | 0 | 0 | 0 | 0 | 0 | 0 |
| | | | example 11 | | | | | | |
| | | | Synthetic | 0 | 0 | 0 | 0 | 0 | 0 |
| | | | example 12 | | | | | | |
| | | | Synthetic | 0 | 0 | 0 | 0 | 0 | 0 |
| | | | example 13 | | | | | | |
| | | | Synthetic | 0 | 0 | 0 | 0 | 0 | 0 |
| | | | example 14 | | | | | | |
| | | | Synthetic | 100 | 0 | 0 | 0 | 0 | 0 |
| | | | example 15 | | | | | | |
| | | | Synthetic | 0 | 100 | 0 | 0 | 0 | 0 |
| | | | example 16 | | | | | | |
| | | | Synthetic | 0 | 0 | 100 | 0 | 0 | 0 |
| | | | example 17 | | | | | | |
| | | | Synthetic | 0 | 0 | 0 | 100 | 0 | 0 |
| | | | example 18 | | | | | | |
| | | | Synthetic | 0 | 0 | 0 | 0 | 100 | 0 |
| | | | example 19 | | | | | | |
| | | | Synthetic | 0 | 0 | 0 | 0 | 0 | 100 |
| | | | example 20 | | | | | | |
| | | | Mass ratio | 0.0080 | 0.0040 | 0.076 | 0.072 | 0.048 | 0.047 |
| | | | [(a1)/(a2)] | | | | | | |
| | | Other | Polyether | 0 | 0 | 0 | 0 | 0 | 0 |
| | | polyols | polyol | | | | | | |
| | | (parts by | Polyester | 0 | 0 | 0 | 0 | 0 | 0 |
| | | mass) | polyol | | | | | | |
| | | | Polycarbonate | 0 | 0 | 0 | 0 | 0 | 0 |
| | | | polyol | | | | | | |

| | | Fluorine atom content of polyol | 0.10 | 0.050 | 1.0 | 1.0 | 1.0 | 1.0 |
|---|---|---|---|---|---|---|---|---|
| | | (P) (parts by mass) | | | | | | |
| | | Hydroxyl value of polyol (P) | 125 | 125 | 115 | 120 | 180 | 185 |
| | | (mgKOH/g) | | | | | | |
| | Polythiol (T) (parts by mass) | | 0 | 0 | 0 | 0 | 0 | 0 |
| | Dibutyltin dilaurate (parts by mass) | | 0.01 | 0.01 | 0.01 | 0.01 | 0.01 | 0.01 |
| | Methyl isobutyl ketone (parts by | | 150 | 150 | 150 | 150 | 150 | 150 |
| | mass) | | | | | | | |
| Formulation | Polyisocyanate (I) (TAKENATE D165N) | | 39 | 39 | 36 | 37 | 56 | 58 |
| of curing | (parts by mass) | | | | | | | |
| agent | Methyl isobutyl ketone (parts by | | 59 | 59 | 54 | 56 | 84 | 87 |
| | mass) | | | | | | | |
| Equivalent ratio [isocyanate group/hydroxyl group] | | | 1 | 1 | 1 | 1 | 1 | 1 |
| Evaluation | Water | Contact angle after one second (°) | 91.5 | 91.0 | 91.2 | 91.8 | 95.2 | 96.0 |
| | spot | Score of contact angle after one | 2 | 2 | 2 | 2 | 2 | 2 |
| | resistance | second | | | | | | |
| | | Change rate of contact angle (%) | 11.0 | 10.9% | 13.5% | 14.3% | 14.1% | 12.5% |
| | | Score of change rate of contact angle | 5 | 4 | 7 | 8 | 8 | 6 |
| | | Overall evaluation (Total score) | 7 | 6 | 9 | 10 | 10 | 8 |

| | | | | | | |
|---|---|---|---|---|---|---|
| Scratch resistance (Number of scratches) | 4 | 9 | 4 | 3 | 3 | 3 |
| Squeegee slidability | B | C | B | B | B | B |
| Stretch rate | 120% | 120% | 120% | 120% | 110% | 110% |

### INDUSTRIAL APPLICABILITY

According to the present invention, it becomes possible to provide the multilayer film including the surface protective layer excellent in the water spot resistance and the scratch resistance and the two-liquid curable coating agent for forming the surface protective layer. The surface protective layer can protect an article surface from a dirt and a scratch and maintain excellent appearance of the article surface.

### REFERENCE SIGNS LIST

S surface protective layer

W water droplet

L tangential line of water droplet

P end point of interface between water droplet W and surface protective layer S

1. A multilayer film comprising:
a substrate layer;
a surface protective layer integrally laminated on a first surface of the substrate layer, the surface protective layer containing a polyurethane which is a reaction product of a polyol (P) having a hydroxyl value of 25 to 380 mgKOH/g and a content of fluorine atoms of 0.01 to 20% by mass and a polyisocyanate (I); and
an adhesive layer integrally laminated on a second surface of the substrate layer.

2. The multilayer film according to claim 1, wherein the hydroxyl value of the polyol (P) is 120 to 180 mgKOH/g.

3. The multilayer film according to claim 1, wherein the polyol (P) contains a (meth)acrylic polyol.

4. The multilayer film according to claim 3, wherein the(meth)acrylic polyol is a polymer of a (meth)acryl-based monomer, the (meth)acryl-based monomer contains a fluorine-containing (meth)acryl-based monomer (a1) and a hydroxyl group-containing (meth)acryl-based monomer (a2), and
a mass ratio of the fluorine-containing (meth)acryl-based monomer (a1) unit to the hydroxyl group-containing (meth)acryl-based monomer (a2) unit, [a mass of the fluorine-containing (meth)acryl-based monomer (a1) unit/a mass of the hydroxyl group-containing (meth)acryl-based monomer (a2) unit], in the (meth)acrylic polyol is 0.003 to 7.5.

5. The multilayer film according to claim 4, wherein the mass ratio of the fluorine-containing (meth)acryl-based monomer (a1) unit to the hydroxyl group-containing (meth)acryl-based monomer (a2) unit, [the mass of the fluorine-containing (meth)acryl-based monomer (a1) unit/the mass of the hydroxyl group-containing (meth)acryl-based monomer (a2) unit], in the (meth)acrylic polyol is 0.003 to 0.9.

6. The multilayer film according to claim 4, wherein the(meth)acryl-based monomer contains a siloxane bond-containing (meth)acryl-based monomer (a3).

7. The multilayer film according to claim 1, wherein the polyol (P) contains at least one kind of polyol selected from the group consisting of a polyether polyol, a polyester polyol, and a polycarbonate polyol.

8. The multilayer film according to claim 1, wherein the polyurethane is a reaction product of the polyol (P), the polyisocyanate (I), and a polythiol (T).

9. The multilayer film according to claim 1, wherein the substrate layer contains at least one of a thermoplastic resin and a thermoplastic elastomer.

10. The multilayer film according to claim 1, wherein the substrate layer contains a polyester-based polyurethane resin or a polyester-based polyurethane thermoplastic elastomer.

11. A film for protecting an automobile comprising the multilayer film according to claim 1.

12. A two-liquid curable coating agent comprising:
a main agent including a polyol (P) having a hydroxyl value of 25 to 380 mgKOH/g and a content of fluorine atoms of 0.01 to 20% by mass; and
a curing agent including a polyisocyanate (I).
